(19) United States
(12) Patent Application Publication
(10) Pub. No.: US 2026/0300762 A1
(43) Pub. Date: Oct. 1, 2026

(54) PREDICTING DETERIORATION OF ENTITIES USING MACHINE LEARNING

(71) Applicant: Krishnav Agarwal, Pleasanton, CA (US)

(72) Inventor: Krishnav Agarwal, Pleasanton, CA (US)

(21) Appl. No.: 19/095,014

(22) Filed: Mar. 30, 2025

(51) Int. Cl. G06N 5/022

(52) U.S. Cl. CPC G06N 5/022

(57) ABSTRACT

An aspect of the present disclosure provides for prediction of deterioration of entities. In an embodiment, one or more images of an entity are received, environmental conditions in the vicinity of the entity are determined, and deterioration of the entity is predicted, based at least in part, on the one or more images of the entity and the environmental conditions, using one or more machine learning models. The one or more images of the entity indicate a first state of the entity, the deterioration includes change in the state of the entity from the first state to a second state, and the prediction includes estimation of the time required for the state of the entity to change from the first state to the second state. The one or more machine learning models include a multimodal regression model, whose outputs include the estimated time and a level of deterioration.

### BACKGROUND OF THE DISCLOSURE

### Technical Field

The present invention relates generally to predicting deterioration of entities, and more specifically to predicting deterioration of entities using machine learning.

### Related Art

Entities are things which have physical existence, and undergo deterioration. Entities include plants, food products, metals, wood, vegetable matter (including agricultural produce), structures, etc.

Deterioration refers to worsening/declining change in state with time. Deterioration also includes the processes of decay, decomposition, corrosion, dilapidation and rotting, well known in the relevant arts.

Machine learning, as well known in the relevant arts, allows machines (computing systems) to learn from data and make decisions or predictions without being explicitly programmed.

Applicant has realized a need for predicting such deterioration of entities. Aspects of the present disclosure are directed to predicting deterioration of entities using machine learning.

### BRIEF DESCRIPTION OF THE DRAWINGS

Example embodiments of the present disclosure will be described with reference to the accompanying drawings briefly described below.

FIG. 1 is a block diagram depicting an example environment in which various aspects of the present disclosure are implemented.

FIG. 2 is a flow chart illustrating the manner in which deterioration of entities is predicted, according to an aspect of the present disclosure.

FIG. 3 is a table showing example input data and output data of a regression model, according to an aspect of the present disclosure.

FIGS. 4A-4C are images depicting deterioration of an entity, in an example implementation of the present disclosure.

FIG. 5 is a block diagram illustrating the details of digital processing system in which various aspects of the present disclosure are operative by execution of appropriate executable modules.

In the drawings, like reference numbers generally indicate identical, functionally similar, and/or structurally similar elements. The drawing in which an element first appears is indicated by the leftmost digit(s) in the corresponding reference number.

### DETAILED DESCRIPTION OF THE EMBODIMENTS OF THE DISCLOSURE

### 1. Overview

An aspect of the present disclosure provides for prediction of deterioration of entities. In an embodiment, one or more images of an entity are received, environmental conditions in the vicinity of the entity are determined, and deterioration of the entity is predicted, based at least in part, on the one or more images of the entity and the environmental conditions, using one or more machine learning models.

In another embodiment, the one or more images of the entity indicate a first state of the entity, the deterioration includes change in the state of the entity from the first state to a second state, and the prediction includes estimation of the time required for the state of the entity to change from the first state to the second state.

In yet another embodiment, the one or more machine learning models include a multimodal regression model, where inputs of the multimodal regression model include the environmental conditions and at least a portion of an image from the one or more images of the entity, and where outputs of the multimodal regression model include the estimated time.

In yet another embodiment, the outputs of the multimodal regression model include a level of deterioration associated with the first state of the entity.

In yet another embodiment, at least one of (i) an alert indicating the estimated time, (ii) at least the portion of the image, and (iii) the level of deterioration, are sent to another system.

In yet another embodiment, the entity is an agricultural produce, and the deterioration includes decay of the agricultural produce due to the environment conditions.

In yet another embodiment, the environmental conditions include one or more of humidity, temperature, precipitation, water-quality, air-quality and pressure. The determination of the environmental conditions includes determination of corresponding (i) measured values of the environmental conditions, or (ii) forecasted values of the environmental values, or (iii) measured values and forecasted values of the environmental conditions.

Several aspects of the present disclosure are described below with reference to examples for illustration. However, one skilled in the relevant art will recognize that the disclosure can be practiced without one or more of the specific details or with other methods, components, materials and so forth. In other instances, well-known structures, materials, or operations are not shown in detail to avoid obscuring the features of the disclosure. Furthermore, the features/aspects described can be practiced in various combinations, though only some of the combinations are described herein for conciseness.

### 2. Example Environment

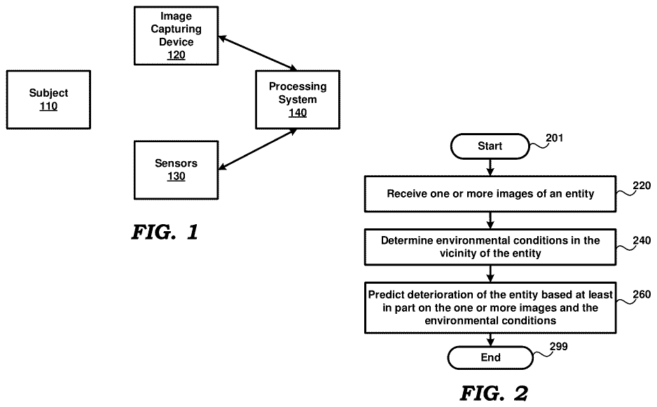

FIG. 1 is a block diagram depicting an example environment in which various aspects of the present disclosure are implemented. The example environment of FIG. 1 is shown containing subject 110, image capturing device 120, sensors 130, and processing system 140. The block diagram is shown with a representative set of components merely for illustration, though typical environments employing aspects of the present disclosure can have many more types and number of systems.

Subject 110 is an entity that can deteriorate with time, and whose deterioration is to be predicted. The deterioration of subject 110 can be due to various reasons, including environmental conditions (such as humidity, temperature, precipitation, water-quality, air-quality, pressure, etc.) in the vicinity (i.e., the location at which the entity is present) of subject 110, as known in the relevant arts. Examples of subject 110 include agricultural produce, plants, food products, metals, wood, structures, etc.

Image capturing device 120 captures one or more images of subject 110 (entity). An image of subject 110 indicates the state (physical state/appearance) of subject 110 at the time of capturing of the image. In an embodiment, image capturing device 120 captures the images of subject 110 at various time instances, based on instruction(s) received from processing system 140. Image capturing device 120 can be any device, known in the relevant arts, that can capture images. In an example implementation, image capturing device 120 is a camera. However, in alternative implementations, image capturing device 120 can be a video recorder that captures a video (i.e., sequence of images) of subject 110. In an embodiment, image capturing device 120 also contains memory to store the captured images.

Image capturing device 120 is communicatively coupled to processing system 140, and sends the one or more captured images to processing system 140. Sending the captured images includes sending either partial images or complete images. In an embodiment, image capturing device 120 sends the captured images to processing system 140 at various time instances, based on instruction(s) received from processing system 140.

In an embodiment, image capturing device 120 captures the images of the entity at various time instances, and sends the captured images to processing system 140 instantaneously (i.e., with negligible delay). In another embodiment, image capturing device 120 captures the images of the entity at various time instances, but sends the captured images to processing system 140 at a later time along with data indicating the time instances at which the images were captured. Techniques known in the relevant arts can be used for sending the capturing images to processing system 140.

Sensors 130 monitor environmental conditions (such as humidity, temperature, precipitation, water-quality, air-quality, pressure, etc.) in the vicinity of subject 110. In an embodiment, monitoring the environmental conditions entails measuring corresponding values of the environmental conditions at various time instances. In an embodiment, sensors 130 measure the values of the environmental conditions at various time instances, based on instruction(s) received from processing system 140. Sensors 130 can be any sensors known in the relevant arts, that can monitor the environmental conditions. In an embodiment, sensors 130 are coupled to a memory, and sensors 130 store the measured values of the environmental conditions in the memory.

Sensors 130 are communicatively coupled to processing system 140, and send data containing the measured values of the environmental conditions to processing system 140. In an embodiment, sensors 130 send the data containing the measured values of the environmental conditions to processing system 140 at various time instances, based on instruction(s) received from processing system 140.

In an embodiment, sensors 130 measure the values of the environmental conditions at various time instances, and send the data containing the measured values to processing system 140 instantaneously (i.e., with negligible delay). In another embodiment, sensors 130 measure the values of the environmental conditions at various time instances, and send the data containing the measured values of the corresponding environmental conditions to processing system 140 at a later time along with data indicating the time instances at which the values of the environmental conditions were measured. Techniques known in the relevant arts can be used for sending the data containing the measured values of the environmental conditions to processing system 140.

It is understood that selection of sensors 130 can be dependent on subject 110 itself, as the environmental conditions that need to be monitored may differ from one type of entity to another type of entity. For example, if subject 110 is iron (a metal), then air-quality may need to be monitored as the air-quality affects the deterioration (i.e., corrosion) of iron. Accordingly, sensors 130 may include sensors that monitor the air-quality.

In case of structures, air-quality and/or water-quality may need to be monitored, and accordingly may require sensors that monitor the air-quality and/or the water-quality. Similarly, in case of plants, precipitation may need to be monitored, and accordingly may require sensors that monitor the precipitation.

Sensors 130 can also be a single sensor, and need not be multiple sensors. Similarly, monitoring environmental conditions also includes the case where only one environmental condition is monitored.

Processing system 140 receives the image(s) of subject 110 from image capturing device 120 and the data containing the measured values of the environmental conditions from sensors 130. In an embodiment, processing system 140 sends instructions to image capturing device 120 and sensors 130, indicating the time instances at which the images of subject 110 need to be captured and sent, and the time instances at which the values of the environmental conditions need to be measured and sent.

In an embodiment, processing system 140 receives the captured images (from capturing device 120) and the measured values of the environmental conditions (from sensors 130) instantaneously. In another embodiment, processing system 140 receives the captured images and the measured values of the environmental conditions at a later time along with the data indicating the time instances at which the images were captured and the environmental conditions were measured.

In an embodiment, processing system also receives forecasted values (i.e., predicted values) of the environmental conditions in the vicinity of the entity, from one or more forecasting models known in the relevant art (for example, Weather Research and Forecasting (WRF) Model).

In an embodiment, the environmental conditions include the measured values (i.e., actual values measured by the sensors) of the environmental conditions, or the forecasted values of the environmental conditions, or both.

Processing system 140 uses/implements machine learning technique(s) (by executing one or more machine learning models). Processing system 140 also uses/implements various image processing techniques. Processing system 140 can be implemented using various devices/systems, as would be apparent to a skilled practitioner. In an example implementation, processing system 140 is a computing device/computer.

Though FIG. 1 shows image capturing device 120 and sensors 130 as separate devices from processing system 140, in alternative environments, image capturing device 120 and sensors 130 can be integrated into processing system 140, as would be apparent to a skilled practitioner. Though not shown in in FIG. 1, processing system 140 may also communicate with other systems (including user systems).

The description is continued with respect to the manner in which deterioration of entities is predicted.

### 3. Flow-Chart

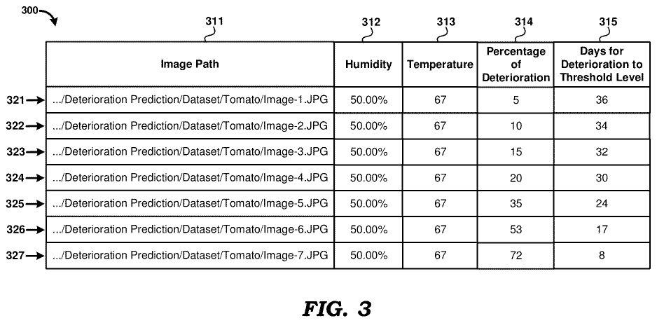

FIG. 2 is a flow chart illustrating the manner in which deterioration of entities is predicted according to an aspect of the present disclosure. The features of FIG. 2 are described with respect to FIG. 1, and the steps of the flow chart of FIG. 2 are described as being performed at processing system 140 also merely for illustration, even though the steps can be performed in other environments and systems as would be apparent to a skilled practitioner. The flow chart begins in step 201, in which control immediately passes to step 220.

In step 220, processing system 140 receives one or more images of an entity (subject 110). The one or more images indicate a first state of the entity. In an embodiment, the first state is a physical state/appearance of the entity at a first time instance. It is understood that an image of the entity depicts the physical state/appearance of the entity at the time of capturing of the image. In an embodiment, the one or more images of the entity are the images captured by image capturing device 120, and processing system 140 receives the one or more images from image capturing device 120.

In step 240, processing system 140 determines environmental conditions in the vicinity of the entity. Determining the environmental conditions entails determining the values of the environmental conditions. In an embodiment, determining the environmental conditions includes determining the measured values (i.e., actual values) of the environmental conditions, or the forecasted values (i.e., predicted values) of the environmental conditions, or both. In an example implementation, processing system 140 determines the environmental conditions based on the data (containing the measured values of the environmental conditions) received from sensors 130, and based on the forecasted values from the data received from one or more forecasting models known in the relevant art.

Processing system 140 may use various data processing techniques, known in the relevant arts, in determining the values of the environmental conditions from the data received from sensors 130, and the data received from the forecasting models.

In step 260, processing system 140 predicts deterioration of the entity, based at least in part, on the one or more images of the entity and the environmental conditions. Deterioration includes change/decline in the state of the entity from the first state to a second state (i.e., in the second state, the physical state/appearance of the entity is worse than that of in the first state) due to the environmental conditions. In an embodiment, the second state is a predetermined state.

In an embodiment, predicting the deterioration includes estimating the time required for the state of the entity to change/decline from the first state to the second state. In an example implementation, predicting the deterioration includes determining a first level of deterioration (for example, in percentage) associated with the first state (i.e., the level of deterioration the first state indicates), determining a second level of deterioration (for example, in percentage) associated with the second state (i.e., the level of deterioration the second state indicates), and estimating the time required for the entity to deteriorate from the first level to the second level.

In an embodiment, processing system 140 uses machine learning technique(s) (by executing one or more machine learning models) for the purpose of predicting the deterioration of subject 110. In an example implementation, processing system 140 uses a regression model (a machine learning model) for predicting the deterioration of subject 110. However, alternative techniques, as would be apparent to a skilled practitioner from the present disclosure, can also be used in predicting the deterioration of the entity.

In an embodiment, processing system 140 sends to another system (not shown in the drawings), at least one of (i) an alert indicating the estimated time, (ii) at least a portion of an image of the entity, and (iii) a level of deterioration associated with the first state of the entity.

The flow chart ends in step 299.

It is understood that such prediction of deterioration of entities helps in predicting shelf-life of agriculture produce and food products, corrosion of metals, dilapidation of structures, decomposition of plants and vegetable matter, etc.

Though not shown in FIG. 2, in an embodiment, processing system 140 repeats the process of FIG. 2 for a period of time (which may be predetermined), to continuously monitor the state of the item and the environmental conditions, and to predict the deterioration of the item.

The description is continued below with respect to example machine learning models of the present disclosure.

### 4. Example Machine Learning Models of the Present Disclosure

According to an aspect of the present disclosure, processing system 140 predicts the deterioration of the entities by executing one or more machine learning models. In an embodiment, processing system 140 executes a multimodal regression model for the prediction of the deterioration of the entities.

As well known in the relevant arts, the multimodal regression model is a supervised learning technique, which learns relationships between different input variables (modalities) and a (continuous) target variable, and predicts an outcome based on inputs. Examples of regression models include Xception, MobileNetV2, EfficientNetV2S, and Resnet50 models. The multimodal regression model can make more accurate and reliable predictions compared to a singular modal regression model, as the multimodal regression model considers various input variables which are relevant in predicting an outcome.

In an embodiment of the present disclosure, the regression model is suitably trained, using techniques known in the relevant arts, with a dataset including (i) images of different entities captured at various instances of time (corresponding to various deterioration levels) until the entities deteriorated by a predetermined level, (ii) timestamps at which the corresponding images are captured and/or time elapsed, (iii) the environmental conditions (such as temperature, humidity, precipitation, pressure, air-quality, water-quality, etc.) in which the entities are present at the corresponding time instances. However, in alternative embodiments, the dataset can include any other data as would be apparent to a skilled practitioner from the present disclosure.

In an example implementation, the dataset is collected until the entities deteriorated by 100 percent. However, in alternative implementations, the dataset can be collected until different predetermined deterioration levels (which can be different for different entities), as would be apparent to a skilled practitioner from the present disclosure.

In an embodiment, the multimodal regression model of the present disclosure receives, among others, the image(s) of an entity (subject 110) captured by image capturing device 120 (or portions extracted from such images), the environmental conditions (actual/measured values received from sensors 130, or forecasted values from the one or more forecasting models, or both), and predicts the deterioration of the entity indicating the time/days by which the entity deteriorates to a predetermined threshold level. It is understood that the predetermined threshold level is also provided as an input to the multimodal regression model. In an example implementation, the multimodal regression model receives the image(s) of the entity (or portions extracted from such images) captured at a time instance, and the environmental conditions measured at the same time instance, and predicts the deterioration of the entity.

Processing system 140 may also execute, a classification model for detection and classification of the images of the entities into different predefined classes or categories. As well known in the relevant arts, the classification model is a supervised learning technique, which learns a mapping from input features to a set of discrete output labels, and categorizes inputs accordingly. The classification model can be a classification model known in the relevant arts. In an example implementation, the classification model is an image classification model (for example, YoloV8 pre-trained model). The classification model is suitably trained, with a dataset containing images of various types of entities, using techniques known in the relevant art.

In an embodiment, processing system 140 executes the classification model prior to executing the regression model, to detect the entities in the images and to classify the images based on the types of the entities in the images. The classification model may (i) indicate the presence/absence of the entities in the images, or (ii) insert bounding boxes around the detected entities in the images, or (iii) provide the co-ordinates (in the images) of the detected entities, or (iv) label the images, or (v) any combination thereof.

In an example implementation, processing system 140 extracts the portions of the images identified by the bounding boxes or the co-ordinates, and provides the extracted portions of the images and the labels as inputs to the regression model. It is understood that the regression model is suitably trained, using the techniques known in the relevant arts, to interpret the labels also.

However, in alternative implementations, the regression model is suitably trained to interpret the coordinates and the images with bounding boxes, and accordingly the images with bounding boxes around the detected entities or the co-ordinates of the detected entities (along with the images) can be provided as inputs to the regression model.

It is understood that, in the alternative implementations where the classification model is not used, the images captured by image capturing device 120 can be directly provided as an input to the regression model (EfficientNetV2S model).

Using the classification model prior to the regression mode can be advantageous in that, by first classifying the images, the regression model focuses only on the specific groups or categories, therefore leading to more accurate predictions.

The description is continued below with respect to an example implementation of the present disclosure.

### 5. Example Implementation of the Present Disclosure

According to an example implementation of the present disclosure, processing system 140 is implemented with a Raspberry Pi v4.0 B connected to input/output devices, image capturing device 120 is implemented with a Raspberry Pi 5MP Camera, and sensors 130 are implemented with BME280 sensor. Both image capturing device 120 and sensors 130 are connected to processing system 140. Tomato is the entity (subject 110) whose deterioration has to be monitored. In the example implementation, trained machine learning models are imported into processing system 140 (for example, from another processing/computing system). Raspberry Pi v4.0 B, Raspberry Pi 5MP Camera, and BME280 sensor are well known in the relevant arts, and are not explained in the present disclosure for the sake of conciseness. It is understood that the aspects of the present disclosure can be implemented with other alternative devices/components, as would be apparent to a skilled practitioner from the present disclosure.

The imported trained machine learning models include a trained YoloV8 model as the classification model and a trained EfficientNetV2S model as the regression model. However, in alternative implementations, other models may be used, as would be apparent to a skilled practitioner from the present disclosure.

YoloV8 model is suitably trained, using techniques known in the relevant art, to detect a tomato (including differentiating tomato from other entities). In an example implementation, YoloV8 model is trained with images of tomato captured at various time instances (corresponding to various levels of deterioration).

EfficientNetV2S model is also suitably trained, using techniques known in the relevant art, with a dataset including (i) images of tomatoes captured at various instances of time (corresponding to various levels of deterioration) until the tomatoes deteriorated by 100 percent, (ii) time elapsed (in hours), (iii) temperature and humidity at the location where the tomatoes are kept (i.e., vicinity of the tomato), at the corresponding time instances. The dataset for EfficientNetV2S model is provided in the form of a CSV file containing records for file paths of the images, temperature data, humidity data, and the time elapsed (in hours). However, in alternative implementations, the dataset can be provided using other techniques, as would be apparent to a skilled practitioner from the present disclosure.

Processing system 140 (with the trained machine learning models), receives an image containing a tomato (for example, from the camera). Processing system 140 also determines the environmental conditions in the vicinity of the tomato. In the example implementation, the environmental conditions correspond to the actual/measured values of temperature and humidity in the vicinity of the tomato (at the time of capturing of the image), and processing system 140 determines the actual/measured values of temperature and humidity based on the data received from BME280 sensor.

Processing system 140 provides the image as an input to YoloV8 model. YoloV8 model detects the entity in the image as a tomato and inserts a bounding box around the tomato, and outputs the image with the bounding box as an output. YoloV8 model also labels the image to indicate that the image contains a tomato. However, in alternative implementations, YoloV8 model outputs the co-ordinates of the tomato in the image with an indication that the image contains a tomato.

Processing system 140 extracts the portion of the image identified by the bounding box, and provides the extracted portion of the image and the actual/measured values of temperature and humidity in the vicinity of the tomato as inputs to EfficientNetV2S model. A threshold level of deterioration (i.e., the predetermined second state) is also provided as an input to EfficientNetV2S model. In this example implementation, the threshold level of deterioration is 90%.

EfficientNetV2S model determines a first level of deterioration (in percentage) associated with the first state of the entity in the extracted portion of the image, determines that 90% (i.e., the threshold level) is the level of deterioration associated with the predetermined second state, and estimates the time required for the tomato to deteriorate from the first level to the threshold level of 90%.

EfficientNetV2S model provides the estimated time and the first level of deterioration associated with the first state of the entity, as outputs. It is understood that in alternative implementations, the outputs of EfficientNetV2S model can be different, as would be apparent to a skilled practitioner.

The example input data and output data of EfficientNetV2S model are shown in FIG. 3. FIG. 3 illustrates table 300 containing columns 311-315 and rows 321-327.

Column 311 (“Image Path”) specifies the path for the portion of the image extracted by processing system 140 based on the bounding box indicated by YoloV8 model, column 312 (“Humidity”) specifies the value of humidity in percentage, column 313 (“Temperature”) specifies the value of temperature in ° F., column 314 (“Percentage of Deterioration”) specifies the level of deterioration associated with the first state of the entity in the image, and column 315 (“Days for Deterioration to Threshold Level”) specifies time/days required for the tomato to deteriorate by 90% (i.e., the threshold level). Columns 311-313 correspond to the inputs of EfficientNetV2S model and columns 314-315 correspond to outputs of EfficientNetV2S model.

Thus, row 321 contains “. . . /Deterioration Prediction/Dataset/Tomato/Image-1.JPG” as path for the portion extracted from the image (of the tomato) captured at a first time instance, “50.00%” as the value of humidity at the first time instance, “67” as the value of temperature in ° F. at the first time instance, “5%” as the percentage of decomposition (indicating that the tomato deteriorated by 5%), and “36” as the days required for the tomato to deteriorate by 90%. Similarly, rows 322-327 contain corresponding entries for the corresponding subsequent time instances.

In FIG. 3, only actual/measured vales of the environmental conditions are input the regression model, and the outputs of the regression model are based on the assumption that the environmental conditions remain the same. However, in alternative implementations, forecasted values can also be input as inputs the regression model.

It is also understood that, in the alternative implementations where the classification model (YoloV8 model) is not used, the images captured by image capturing device 120 can be directly provided as an input to the regression model (EfficientNetV2S model).

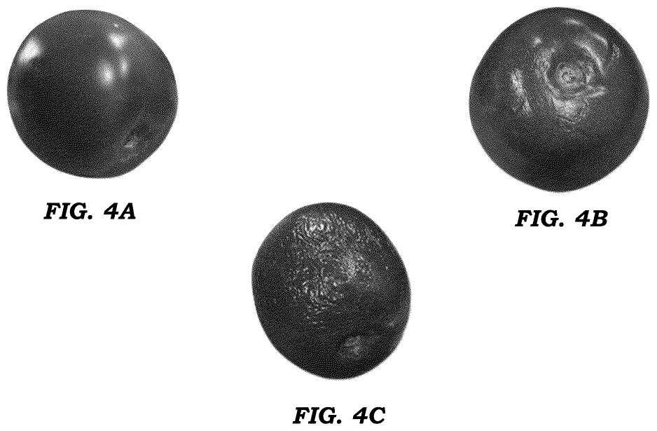

FIGS. 4A-4C are example images depicting deterioration of the tomato. FIG. 4A depicts an image of a (fresh) tomato, FIG. 4B depicts an image of the tomato at the first time instance corresponding to row 321, and FIG. 4C depicts an image of the tomato at the third time instance corresponding to row 323.

In the example implementation, processing system 140 also sends to another system (for example, a user system), an alert indicating the estimated time for the entity to deteriorate to the threshold level, the image of the entity (or a portion of the image), and the level of deterioration of the entity associated with the first state of the entity in the image. However, in alternative implementations, processing system 140 may send only the alert or only the image (or a portion of the image) or only the level of deterioration of the entity, or any other information as would be apparent to a skilled practitioner. Processing system 140 uses techniques known in the relevant arts for sending the alert and the image.

However, in alternative implementations, processing system 140 sends the alert only if the level of deterioration of the entity is beyond a second threshold level (for example, if the deterioration is beyond 30%).

In the example implementation, processing system 140 also displays the estimated time and the level of deterioration on a display connected to processing system 140.

Thus, present disclosure discloses techniques for predicting deterioration of entities using machine learning. It is understood that deterioration may be referred to as decay or decomposition or corrosion or dilapidation or rotting based on the entity. For example, in case of metals, deterioration may be referred to as corrosion; in case of agricultural produce, deterioration may be referred to as decay/decomposition/rotting; in case of vegetable matter, deterioration may be referred to as decomposition/decay; in case of structures (for example, buildings), deterioration may be referred to as dilapidation. The present disclosure covers all such equivalents.

It should be further appreciated that the features described above can be implemented in various embodiments as a desired combination of one or more of hardware, software, and firmware. The description is continued with respect to an embodiment in which various features are operative.

### 6. Digital Processing System

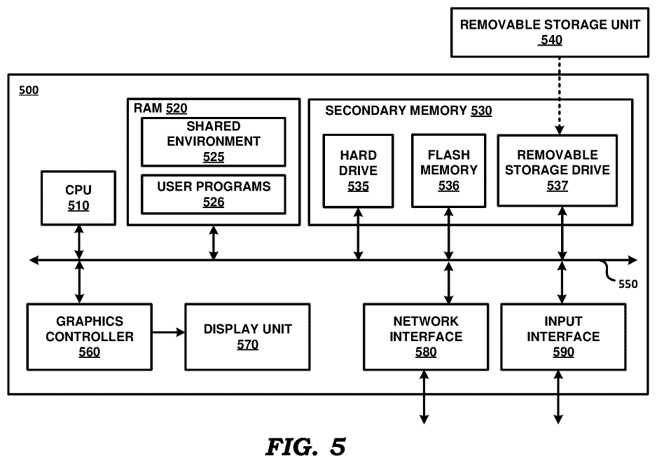

FIG. 5 is a block diagram illustrating the details of digital processing system 500 in which various aspects of the present disclosure are operative by execution of appropriate executable modules. Digital processing system 500 corresponds to processing system 140.

Digital processing system 500 may contain one or more processors such as a central processing unit (CPU) 510, random access memory (RAM) 520, secondary memory 530, graphics controller 560, display unit 570, network interface 580, and input interface 590. All the components except display unit 570 may communicate with each other over communication path 550, which may contain several buses as is well known in the relevant arts. The components of FIG. 5 are described below in further detail.

CPU 510 may execute instructions stored in RAM 520 to provide several features of the present disclosure. CPU 510 may contain multiple processing units, with each processing unit potentially being designed for a specific task. Alternatively, CPU 510 may contain only a single general-purpose processing unit.

RAM 520 may receive instructions from secondary memory 530 using communication path 550. RAM 520 is shown currently containing software instructions constituting shared environment 525 and application programs 526. Shared environment 525 includes operating systems, device drivers, virtual machines, etc., which provide a (common) run time environment for execution of user programs 526. The various modules described above may be contained in application programs 526 executing in shared environment 525.

Graphics controller 560 generates display signals (e.g., in RGB format) to display unit 570 based on data/instructions received from CPU 510. Display unit 570 contains a display screen to display the images defined by the display signals. Input interface 590 may correspond to a keyboard and a pointing device (e.g., touch-pad, mouse) that may be used to provide appropriate inputs (e.g., for editing the configuration data). Network interface 580 provides connectivity to a network (e.g., using Internet Protocol).

Secondary memory 530 may contain hard drive 535, flash memory 536, and removable storage drive 537. Secondary memory 530 may store the data (for example, portions of the configuration data as appropriate files) and software instructions (for implementing the flowchart of FIGS. 2 and 4), which enable digital processing system 500 to provide several features in accordance with the present disclosure. The code/instructions stored in secondary memory 530 either may be copied to RAM 520 prior to execution by CPU 510 for higher execution speeds, or may be directly executed by CPU 510.

Some or all of the data and instructions may be provided on removable storage unit 540, and the data and instructions may be read and provided by removable storage drive 537 to CPU 510. Removable storage unit 540 may be implemented using medium and storage format compatible with removable storage drive 537 such that removable storage drive 537 can read the data and instructions. Thus, removable storage unit 540 includes a computer readable (storage) medium having stored therein computer software and/or data. However, the computer (or machine, in general) readable medium can be in other forms (e.g., non-removable, random access, etc.).

In this document, the term “computer program product” is used to generally refer to removable storage unit 540 or hard disk installed in hard drive 535. These computer program products are means for providing software to digital processing system 500. CPU 510 may retrieve the software instructions, and execute the instructions to provide various features of the present disclosure described above.

The term “storage media/medium” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage memory 530. Volatile media includes dynamic memory, such as RAM 520. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 550. Transmission media can also take the form of acoustic or light waves, such as those generated during radio-wave and infra-red data communications.

### 7. Conclusion

Reference throughout this specification to “one embodiment”, “an embodiment”, or similar language means that a particular feature, structure, or characteristic described in connection with the embodiment is included in at least one embodiment of the present disclosure. Thus, appearances of the phrases “in one embodiment”, “in an embodiment” and similar language throughout this specification may, but do not necessarily, all refer to the same embodiment. Furthermore, the described features, structures, or characteristics of the disclosure may be combined in any suitable manner in one or more embodiments.

While various embodiments of the present disclosure have been described above, it should be understood that they have been presented by way of example only, and not limitation. Thus, the breadth and scope of the present disclosure should not be limited by any of the above-described exemplary embodiments.

It should be understood that the figures illustrated in the attachments highlighting the functionality and advantages of the present disclosure are presented for example purposes only. The present disclosure is sufficiently flexible and configurable, such that it may be utilized in ways other than that shown in the accompanying figures.

Further, the purpose of the following Abstract is to enable the Patent Office and the public generally, and especially the scientists, engineers and practitioners in the art who are not familiar with patent or legal terms or phraseology, to determine quickly from a cursory inspection the nature and essence of the technical disclosure of the application. The Abstract is not intended to be limiting as to the scope of the present disclosure in any way.

What is claimed is:

1. A method of predicting deterioration of entities, the method being implemented at a processing system, the method comprising:
receiving one or more images of an entity;
determining environmental conditions in the vicinity of said entity; and
predicting, using one or more machine learning models, deterioration of said entity based at least in part on said one or more images of said entity and said environmental conditions.

2. The method of claim 1, wherein:
said one or more images of said entity indicating a first state of said entity;
said deterioration comprising change in the state of said entity from said first state to a second state; and
said predicting comprising estimating the time required for the state of said entity to change from said first state to said second state.

3. The method of claim 2, wherein said one or more machine learning models comprising a multimodal regression model,
wherein inputs of said multimodal regression model comprising said environmental conditions and at least a portion of an image from said one or more images of said entity, and
wherein outputs of said multimodal regression model comprising said estimated time.

4. The method of claim 3, wherein said outputs of said multimodal regression model comprising a level of deterioration associated with said first state of said entity.

5. The method of claim 4, further comprising sending to another system at least one of (i) an alert indicating said estimated time, (ii) at least said portion of said image, and (iii) said level of deterioration.

6. The method of claim 1, wherein said entity is an agricultural produce, and
wherein said deterioration comprising decay of said agricultural produce due to said environment conditions.

7. The method of claim 1, wherein said environmental conditions comprising one or more of humidity, temperature, precipitation, water-quality, air-quality and pressure; and
wherein said determining of said environmental conditions comprising determining corresponding (i) measured values of said environmental conditions, or (ii) forecasted values of said environmental values, or (iii) measured values and forecasted values of said environmental conditions.

8. A processing system for predicting deterioration of entities, said processing system comprising:
a memory to store instructions;
one or more processors to execute said instructions stored in said memory to cause said processing system to perform the actions of:
receiving one or more images of an entity;
determining environmental conditions in the vicinity of said entity; and
predicting, using one or more machine learning models, deterioration of said entity based at least in part on said one or more images of said entity and said environmental conditions.

9. The processing system of claim 8, wherein:
said one or more images of said entity indicating a first state of said entity;
said deterioration comprising change in the state of said entity from said first state to a second state; and
said predicting comprising estimating the time required for the state of said entity to change from said first state to said second state.

10. The processing system of claim 9, wherein said one or more machine learning models comprising a multimodal regression model,
wherein inputs of said multimodal regression model comprising said environmental conditions and at least a portion of an image from said one or more images of said entity, and
wherein outputs of said multimodal regression model comprising said estimated time.

11. The processing system of claim 10, wherein said outputs of said multimodal regression model comprising a level of deterioration associated with said first state of said entity.

12. The processing system of claim 11, further sending to another system at least one of (i) an alert indicating said estimated time, (ii) at least said portion of said image, and (iii) said level of deterioration.

13. The processing system of claim 8, wherein said entity is an agricultural produce, and
wherein said deterioration comprising decay of said agricultural produce due to said environment conditions.

14. The processing system of claim 8, wherein said environmental conditions comprising one or more of humidity, temperature, precipitation, water-quality, air-quality and pressure; and
wherein said determining of said environmental conditions comprising determining corresponding (i) measured values of said environmental conditions, or (ii) forecasted values of said environmental values, or (iii) measured values and forecasted values of said environmental conditions.

15. A non-transitory machine readable medium storing one or more sequences of instructions for predicting deterioration of entities, wherein execution of said one or more instructions by one or more processors contained in a digital processing system causes the digital processing system to perform the actions of:
receiving one or more images of an entity;
determining environmental conditions in the vicinity of said entity; and
predicting, using one or more machine learning models, deterioration of said entity based at least in part on said one or more images of said entity and said environmental conditions.

16. The non-transitory machine readable medium of claim 15, wherein:
said one or more images of said entity indicating a first state of said entity;
said deterioration comprising change in the state of said entity from said first state to a second state; and
said predicting comprising estimating the time required for the state of said entity to change from said first state to said second state.

17. The non-transitory machine readable medium of claim 16, wherein said one or more machine learning models comprising a multimodal regression model,
wherein inputs of said multimodal regression model comprising said environmental conditions and at least a portion of an image from said one or more images of said entity, and
wherein outputs of said multimodal regression model comprising said estimated time.

18. The non-transitory machine readable medium of claim 17, further comprising one or more instructions for:
sending to another system at least one of (i) an alert indicating said estimated time, (ii) at least said portion of said image, and (iii) a level of deterioration associated with said first state of said entity.

19. The non-transitory machine readable medium of claim 15, wherein said entity is an agricultural produce, and
wherein said deterioration comprising decay of said agricultural produce due to said environment conditions.

20. The non-transitory machine readable medium of claim 15, wherein said environmental conditions comprising one or more of humidity, temperature, precipitation, water-quality, air-quality and pressure; and
wherein said determining of said environmental conditions comprising determining corresponding (i) measured values of said environmental conditions, or (ii) forecasted values of said environmental values, or (iii) measured values and forecasted values of said environmental conditions.
